(19) United States
(12) Patent Application Publication
(10) Pub. No.: US 2019/0242404 A1
(43) Pub. Date: Aug. 8, 2019

(54) FAN ASSEMBLIES

(71) Applicant: TTI (MACAO COMMERCIAL OFFSHORE) LIMITED, Macau (MO)

(72) Inventor: J. Porter Whitmire, Greenville, SC (US)

(21) Appl. No.: 16/266,472

(22) Filed: Feb. 4, 2019

Related U.S. Application Data
(60) Provisional application No. 62/627,548, filed on Feb. 7, 2018.

(51) Int. Cl. F04D 29/44; F04D 25/08; F04D 29/42; F21V 33/00

(52) U.S. Cl. CPC F04D 29/441; F04D 25/08; F05B 2240/14; F21V 33/0092; F05B 2240/123; F04D 29/4226

(57) ABSTRACT

A fan assembly may include a base securable to a surface. The base may include a cavity and an inlet in fluid communication with the cavity. The fan assembly may also include a motor assembly disposed in the cavity. The motor assembly may be operable to draw air in through the inlet and into the cavity. The fan assembly may further include a nozzle coupled to the base. The nozzle may define a central axis oriented at an oblique angle relative to the surface and an outlet in fluid communication with the cavity of the base. The outlet may direct the air out of the nozzle in a direction generally parallel to the central axis.

### CROSS-REFERENCE TO RELATED APPLICATION

This application claims the benefit of U.S. Provisional Patent Application No. 62/627,548, filed Feb. 7, 2018, the entire contents of which are incorporated by reference herein.

### BACKGROUND

The present subject matter relates to a fan assembly, and more specifically, to a fan assembly configured to be positioned adjacent a mirror.

Some fans include blades or impellers positioned within a housing such that the blades or impellers are not visible to a user. Such fans are referred to as bladeless fans. A bladeless fan typically draws air in through an opening of the housing and guides the air through inner pathways until the air is pushed out of the inner pathways in a given direction. Taking advantage of the Bernoulli principle and Coanda effect, high velocity air expelled from the bladeless fans draws additional air into the airflow zone, thereby increasing a total air flow.

### SUMMARY

In one embodiment, a fan assembly may include a base securable to a surface. The base may include a cavity and an inlet in fluid communication with the cavity. The fan assembly may also include a motor assembly disposed in the cavity. The motor assembly may be operable to draw air in through the inlet and into the cavity. The fan assembly may further include a nozzle coupled to the base. The nozzle may define a central axis oriented at an oblique angle relative to the surface and an outlet in fluid communication with the cavity of the base. The outlet may direct the air out of the nozzle in a direction generally parallel to the central axis.

In another embodiment, a fan assembly may include a base for attachment to a surface proximate a mirror. The base may at least partially define a cavity and an inlet in fluid communication with the cavity. The fan assembly may also include a motor assembly disposed in the base. The motor assembly may be operable to draw air into the cavity through the inlet. The fan assembly may further include a nozzle having a first wall and a second wall spaced apart from the first wall, a central opening at least partially defined by the second wall, and a channel disposed between the first and second walls. The channel may be in fluid communication with the cavity of the base. The nozzle may also have an outlet formed in the second wall. The outlet may be configured to direct air out of the nozzle toward the mirror. The fan assembly may further include a heating element. The heating element may be configured to heat the air passing through the channel. The fan assembly may also include a light emitter supported by the nozzle. The light emitter may be configured to direct light through the central opening.

In yet another embodiment, a fan and mirror assembly may include a mirror having a mirrored surface and a fan assembly disposed proximate to the mirror. The fan assembly may include a base secured to a wall above the mirror. The base may define an inlet and a cavity. The fan assembly may also include a motor assembly disposed in the base. The motor assembly may be configured to draw air into the cavity through the inlet. A nozzle may be coupled to the base. The nozzle may define a central axis oriented at an oblique angle relative to the mirrored surface. The nozzle may define an outlet configured to direct air out of the nozzle in a direction generally parallel to the central axis and toward the mirrored surface. The fan assembly may further include a heating element supported by the nozzle for heating air directed out of the nozzle. The fan assembly may also include a light emitter supported by the nozzle.

Other aspects of the present subject matter will become apparent by consideration of the detailed description and accompanying drawings.

### BRIEF DESCRIPTION OF THE DRAWINGS

FIG. 1 is a perspective view of a fan assembly mounted adjacent a mirror.

FIG. 2 is a top plan view of the fan assembly of FIG. 1.

FIG. 3 is a cross-sectional view of the fan assembly of FIG. 1, viewed along line 3-3.

FIG. 4 is another cross-sectional view of the fan assembly of FIG. 1, viewed along line 4-4.

FIG. 5 is yet another cross-sectional view of the fan assembly of FIG. 1, viewed along line 5-5.

FIG. 6 is a perspective view of another fan assembly mounted adjacent a mirror.

### DETAILED DESCRIPTION

Before any embodiments are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present subject matter relates to a fan assembly. The fan assembly may be configured mount to a surface (e.g., a wall, a mounting surface, and/or the like) on or over which a mirror is disposed, and in some embodiments adjacent to the mirror for providing air flow over the mirror and/or a mirrored surface of the mirror.

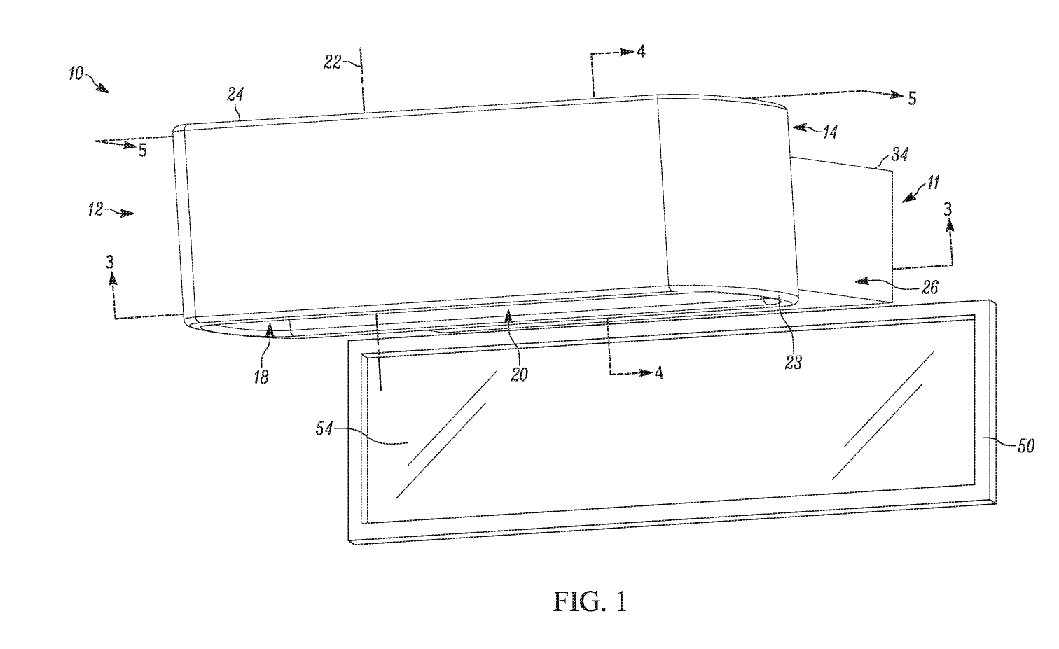

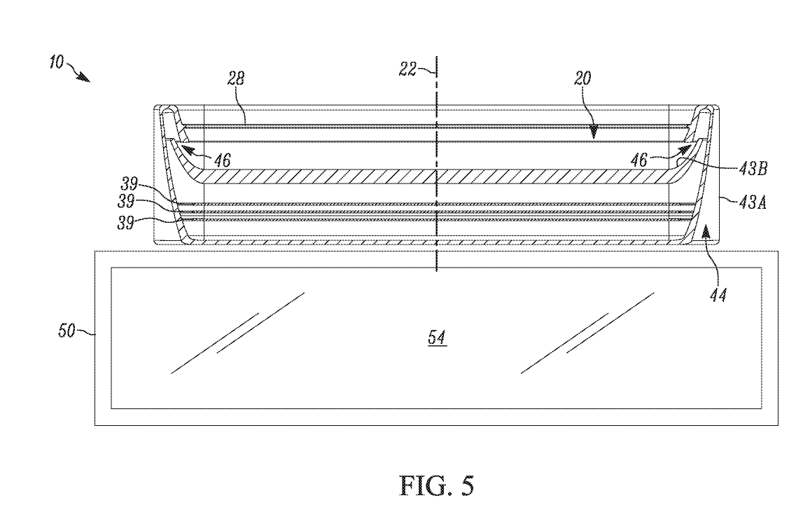

FIGS. 1-5 illustrate a fan assembly, generally designated 10. The fan assembly 10 may include a rear portion 11 and a front portion 12. The illustrated fan assembly 10 may include an attachment for a mirror (e.g., a mirror attachment) or a fan that is configured to couple to and/or be positioned adjacent a frame 50 of a mirror 54 or a mirrored surface. More particularly, the rear portion 11 of the fan assembly 10 may be configured to couple, attach and/or face a wall or other support structure (e.g., a ceiling) adjacent an edge of the frame 50 of the mirror 54, and the front portion 12 may extend a distance away from the wall. In some embodiments, the fan assembly 10 may be coupled directly to the frame 50 of the mirror 54. In still other embodiments, the mirror 54 may not include the frame 50, and the fan assembly may be coupled directly to the mirror 54 itself.

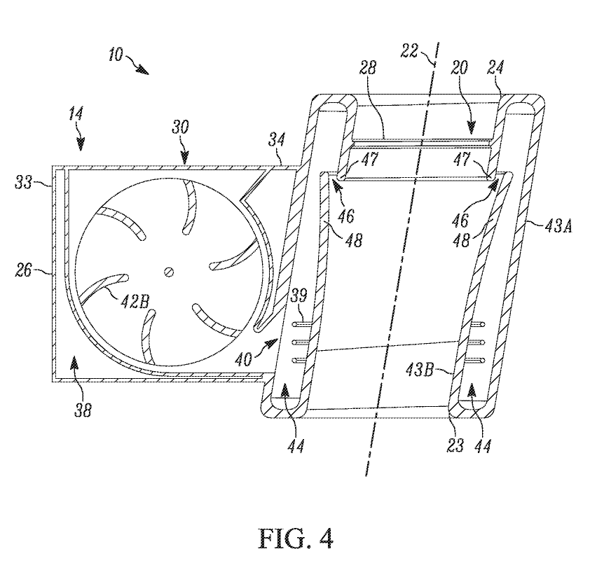

As shown in FIG. 1, the front portion 12 of the fan assembly 10 may include a body 14 having a nozzle 18, and the rear portion 11 of the fan assembly 10 may include a base 26. The nozzle 18 may include an annular nozzle (e.g., an annularly shaped nozzle) that defines a central opening 20. As shown in the illustrated embodiment, the nozzle 18 may include an oblong rounded shape. In other embodiments, the nozzle 18 may include any other suitable shape, such as a circular shape, a square shape, a rectangular shape, a hexagonal shape, an oval shape, an oblong shape, a symmetrical shape (e.g., respective to a central axis 22), an asymmetrical shape (e.g., respective to the central axis 22), and/or the like. The nozzle 18 may include and/or define the central axis 22, which may extend through a center of the central opening 20. The central opening 20 may include a first, lower end 23 disposed proximate the mirror 54, and a second, upper end 24 opposite the lower end 23. The base 26 may be coupled to the body 14 and be offset a distance from the nozzle 18, in some embodiments. For example, the base 26 may extend radially outward or away from the nozzle 18. The base 26 may include a first, rear surface 33 (see e.g., FIG. 4) that may be securable to the mirror 54, a wall, or other support structure so that the rear surface 33 and the support structure are parallel and/or such that the rear surface 33 and the support structure face each other.

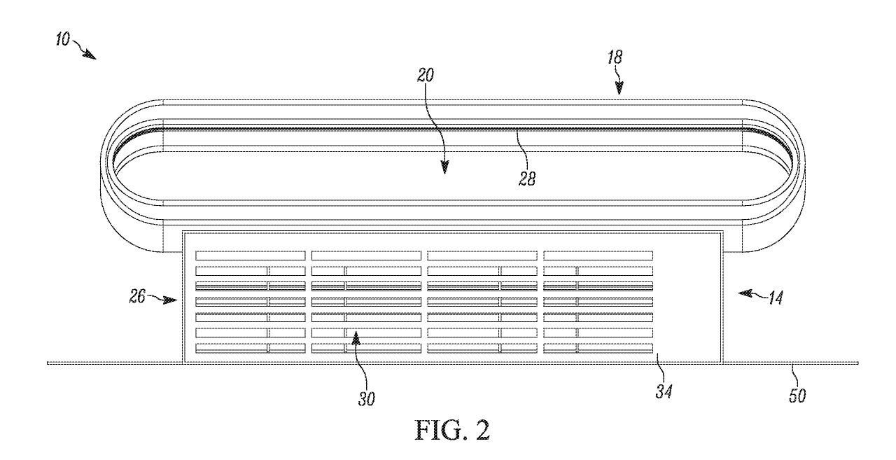

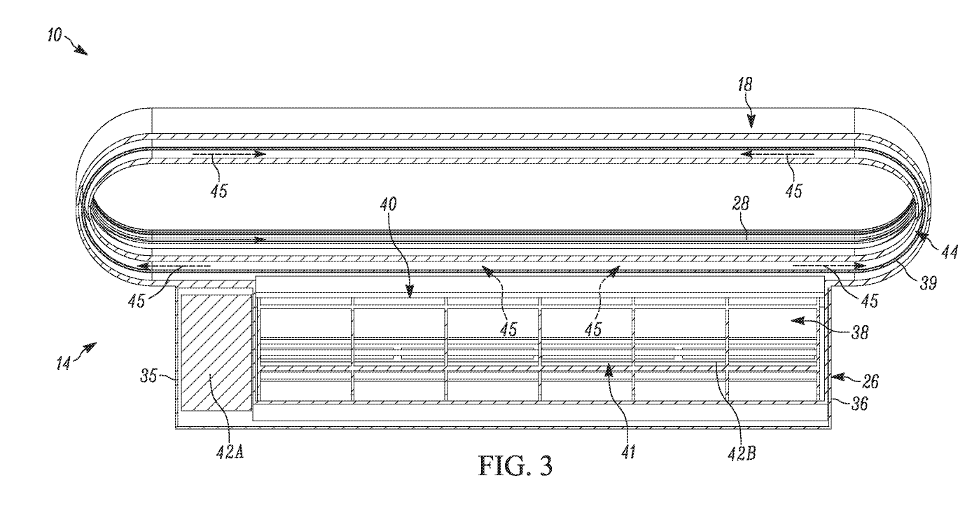

As shown in FIGS. 2 and 3, the fan assembly 10 may additionally include one or more light emitters 28. The light emitters 28 may include, for example, light emitting diodes (LEDs) or other suitable luminaires (e.g., incandescent bulbs, fluorescent bulbs, and/or the like). The light emitters 28 may be supported by the nozzle 18 and be positioned within the central opening 20 and/or otherwise proximate to the central opening 20. The light emitters 28 may be configured to emit light in a direction that is parallel, or substantially parallel, to the central axis 22 and out of the central opening 20. As shown in the illustrated embodiment, the light emitters 28 may include one or more LED strip(s) extending around the perimeter of the central opening 20. Additionally, or alternatively, in some embodiments, multiple light emitters may be spaced apart in discrete locations around an inner surface of the nozzle 18. In still other embodiments, the fan assembly 10 may include a single light emitter, or the light emitters 28 may be omitted.

As shown in FIG. 2, the base 26 may include an inlet or an inlet region disposed therein. As shown in the illustrated embodiment, the inlet may be defined by one or more intake apertures or intake holes 30 formed in a second, upper surface 34 of the base 26. The upper surface 34 may be generally orthogonal with respect to the rear surface 33. In other embodiments, the intake holes 30 may be formed elsewhere on the base 26 (e.g., on a lower surface of the base 26, on a side surface of the base 26 between the upper and lower surfaces, and/or the like). The intake holes 30 may provide fluid communication between an external environment (e.g., a room) and a cavity 38 (see e.g., FIG. 3) defined within the base 26 as described herein. For example, air from the external environment may be pulled into and/or otherwise enter the fan assembly 10 by way of entering the one or more intake holes 30, and the air may be redistributed out from the fan assembly 10 for defogging a mirror, cooling a user, and/or the like as described herein.

As shown in FIGS. 3 and 4, the base 26 may also include a cavity outlet or exhaust opening 40 formed in a surface between the base 26 and the nozzle 18. In other embodiments, multiple openings 40 may be spaced along the surface between the base 26 and the nozzle 18. The exhaust opening 40 may provide fluid communication between the internally disposed cavity 38 of the base 26 and a channel 44 defined by the nozzle 18. In the illustrated embodiment, the exhaust opening 40 may be formed at a lower end of the base 26 (e.g., proximate the lower end 23, see e.g., FIG. 4).

As further shown in FIGS. 3 and 4, the channel 44 may be formed by or between a first, outer wall 43A and a second, inner wall 43B of the nozzle 18. In some embodiments, the outer wall 43A and the inner wall 43B may be disposed opposite each other, for example, and face each other across the channel 44. In some embodiments, the channel 44 may form a substantially continuous opening (i.e., the channel 44 may extend uninterrupted around an entire perimeter of the nozzle 18) for facilitating a fluid communication between openings 40 and an outlet 46 as described herein. In the illustrated embodiment, the outer and inner walls 43A, 43B may be parallel or substantially parallel with respect to each other and obliquely oriented with respect to the rear surface 33 and the support structure. The walls 43A, 43B may be angled so that the lower end 23 is disposed closer to the rear surface 33 or the support structure than the upper end 24. In some embodiments, the outer and inner walls 43A, 43B may be non-obliquely oriented with respect to the rear surface 33 and the support structure. For example, in some embodiments outer and inner walls 43A, 43B may be substantially parallel to the rear surface 33 and the support structure.

Referring to FIG. 3, and in some embodiments, a fluid path 45 may be formed and/or defined in the fan assembly 10. For example, the fluid path 45 may initiate at the intake holes 30, extend through the cavity 38, extend through the exhaust opening 40, and extend to the channel 44. The channel 44 may be in fluid communication with an outlet 46 (FIG. 4) formed on an inner periphery of the nozzle 18. In particular, the inner wall 43A may include a first, upper segment 47 (FIG. 4) and a second, lower segment 48 (FIG. 4) that may be discontinuous from the upper segment 47, so that the outlet 46 may be formed as a gap disposed between the upper segment 47 and the lower segment 48. The upper segment 47 may extend generally parallel to the central axis 22 from the upper end 24 toward the lower end 23. The lower segment 48 may extend generally parallel to the central axis 22 from the lower end 23 toward the upper end 24. In the illustrated embodiment, the upper segment 47 may be shorter than the lower segment 48 so that the outlet 46 may be disposed more proximate to the upper end 24. However, the outlet 46 may be disposed more proximate to the lower end 23 in some embodiments.

In some embodiments, the upper segment 47 may partially overlap the lower segment proximate the upper end 24, and may be disposed radially inside of the lower segment (i.e., disposed closer to the central axis 22). The outlet 46 may include an opening formed between the upper and lower segments 47, 48. The outlet 46 may be located closer to the upper end 24 than to the lower end 23. The outlet 46 may also be located above or higher than the exhaust opening 40. In this way, the air may be pressurized upon entering the opening 40 and/or leaving the outlet 46 for improving (e.g., increasing, optimizing, and/or the like) the airflow volume or velocity expelled by the fan assembly 10. Air may flow around the lower segment 47 and through the outlet 46 defined between the lower and upper segments 47, 48. The upper segment 47 may direct air towards the lower end 23 in a direction substantially parallel to the central axis 22 (i.e., toward the surface of the mirror 54). In some embodiments, the outlet 46 may include a continuous gap or opening extending along an entire perimeter of the inner wall 43B. In other embodiments, the outlet 46 may include multiple discrete openings disposed along the perimeter of the inner wall 43B. In some embodiments, a wall or projection (not shown) may divide the channel 44 into two or more sections so air traveling through the nozzle 18 does not continuously circulate.

In some embodiments, the fan assembly 10 may further include a motor assembly 41 positioned within the cavity 38 of the base 26. The motor assembly 41 may include a motor 42A and a fan 42B coupled to the motor 42A. The motor 42A may be configured to generate an air flow by driving an impeller of the fan 42B. In particular, the motor assembly 41 may be positioned between the intake holes 30 and the exhaust opening 40 to draw air into the cavity 38 through the intake holes 30 and propel the air out of the cavity 38 through the exhaust opening 40. In the illustrated embodiment, the motor 42A may be disposed proximate a first end 35 of the cavity 38, and the fan 42B may extend from the motor 42A towards a second, opposing end 36 of the cavity 38. The air propelled by the fan 42B may be directed through the channel 44 of the nozzle 18 and be expelled out of the outlet 46. As such, the fan assembly 10 may function similar to and/or as a bladeless fan.

With reference to FIGS. 3-5, the fan assembly 10 may also include a heating element 39. The illustrated heating element 39 may include one or more heating coils positioned within the channel 44. The one or more heating coils may be disposed (e.g., wrap, wind, extend, and/or the like) around the inner wall 43B of the nozzle 18, in some embodiments. In some embodiments, a plurality of discrete heating elements 39 (e.g., discrete heating sources, discrete adhesive heating sources, discrete heating films, and/or the like) may be disposed around the nozzle 18 and/or the inner wall 43B of the nozzle. The illustrated fan assembly 10 may include three heating coils, although any quantity of heating coils may be provided. At least a portion of the heating element 39 may be positioned proximate to the exhaust opening 40 (e.g., at a lower end of the channel 44 proximate the lower end 23). Heat produced by the heating element 39 may be transferred to and/or dissipate into the air flowing through the channel 44 via forced convection. The air may increase in temperature along the fluid path 45 as additional heat is transferred from the heating element 39 to the air passing through the fan assembly 10. In this way, the heated air may be used to reduce or inhibit moisture from accumulating on the mirror 54 by way of blowing air over the mirrored surface of the mirror 54.

With reference to FIGS. 1-5, the fan assembly 10 may be coupled to and/or be disposed adjacent the mirror 54, and may be oriented to direct air across the mirror 54 (e.g., in a direction generally parallel to the central axis 22). The central axis 22 may be oriented obliquely relative to the mirror 54 (e.g., the central axis 22 may form an acute angle with the mirror 54). The inclination of the walls 43A, 43B may assist in directing the air slightly horizontally toward the support surface, and therefore the mirror 54. The light emitters 28 may also be configured to illuminate the mirror 54 and/or the surrounding room. In some embodiments, the fan assembly 10 may be controlled by a switch positioned within the room. The switch can be mounted to the mirror 54 or to a wall in the room. The switch may be operable to independently control any one of the motor assembly 41, the light emitters 28, and the heater 39. In other embodiments, the fan assembly 10 may additionally or alternatively be controlled by a remote control or an app on a smartphone or computer.

In some embodiments, the mirror 54 may be positioned in a bathroom or other room where steam may be present. While running hot water (e.g., while taking a shower, washing a face or hands, and/or the like), steam may get into the air and condense on a surface of the mirror 54, as the air may be warmer than the mirror 54. The condensation may cause the mirror 54 to fog up, which may make it difficult for a user to observe his or her reflection in the mirror 54. Blowing air across the surface of the mirror 54 with the fan assembly 10 may reduce the amount of steam that condenses on the mirror 54, as water droplets may be inhibited from forming on the mirror 54, and instead may be forced back into the air. Additionally, or alternatively, by blowing warm air over the mirror, the fan assembly 10 may warm the surface of the mirror 54. In this way, the temperature differential between the mirror 54 and the air may be reduced, which may further reduce the amount of condensation forming on the mirror 54.

In some embodiments, the front portion 12 of the fan assembly 10 may be moveable (e.g., pivotable, rotatable, slidable, and/or the like) relative to the rear portion 11. For example, a user may pivot the nozzle 18 and/or the body 14 including the nozzle 18 to adjust an angle between the central axis 22 and the mirror 54. Adjusting the front portion 12 may allow a user to control a direction of the air by aiming the outlet 46 to blow air across different portions of the mirror 54, which may better defog those portions. Adjusting the front portion 12 may also allow the user to aim the direction of light being output by the light emitters 28. An adjustment mechanism (not shown, e.g., a hinge, joint, a collar, a pivot point, and/or the like) may be disposed between the rear portion 11 and the front portion 12. In some embodiments, the adjustment mechanism may allow for adjustments between a finite number of discrete positions, while in other embodiments, the adjustment mechanism may allow for adjustments between an infinite number of positions. In some embodiments, the adjustment mechanism may be manually actuated. In other embodiments, the adjustment mechanism may be electrically controlled (e.g., by a motor). In further embodiments, the front portion 12 may continuous move or oscillate during operation of the fan assembly 10.

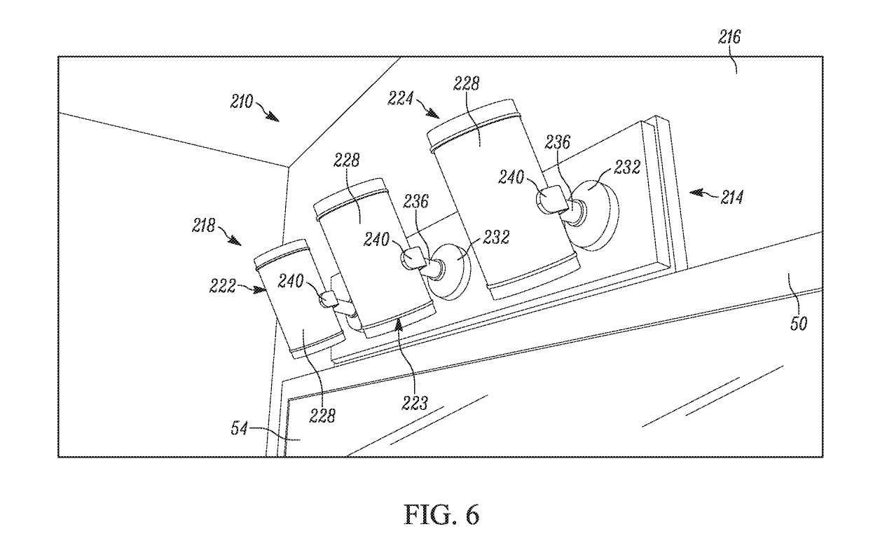

FIG. 6 illustrates another embodiment of a fan assembly, generally designated 210. The fan assembly 210 may include a rear portion 214 configured to be secured (e.g., coupled, attached, fastened, adhered, and/or the like) to a wall 216 above and/or otherwise proximate to a frame 50 of a mirror 54, and the fan assembly 210 may include a front portion 218 coupled to the rear portion 214 and extending out from the wall 216. The front portion 218 may include multiple discrete fan assembly units 222, 223, 224, each with a separate nozzle 228 and light emitters (not shown) disposed within each nozzle 228. Each nozzle 228 may have a generally cylindrical shape. In other embodiments, the front portions 218 may include a single fan assembly unit, two fan assembly units, more than two fan assembly units and/or the like. Additionally, or alternatively, the front portions 218 may include different shapes that may not be cylindrical (e.g., rectangular shapes, spherical shapes, conical shapes, and/or the like). In some embodiments, the rear portion 214 may include intake holes and a central motor assembly (neither shown in this view, as described above). The intake holes and motor assembly may be configured to draw air into the fan assembly 210 through the intake holes, and expel air though the nozzle 228 of each discrete fan assembly units 222-224. In other embodiments, each discrete fan assembly units 222-224 may include respective intake holes and/or motor assemblies.

In some embodiments, each discrete fan assembly units 222-224 may include a mounting base 232 mounted to the rear portion 214. A rod 236 may extend from the mounting base 232, and a collar 240 may be coupled to the nozzle 228. The rod 236 and collar 240 may provide the nozzle with multiple (e.g., two, three, and/or the like) axes of rotation (e.g., about an axis generally perpendicular to the wall 216, and about an axis generally parallel to the wall 216). In some embodiments, the rod 236 and/or collar 240 may employ and/or be formed as a universal joint allowing for multiple degrees of freedom for each discrete fan assembly unit 222-224, so that the fan assembly units 222-224 may be independently movable and/or positionable respective to the mirror 54. In this way, a user may make rotational adjustments to each nozzle 228 individually in order to control the direction of light and/or airflow output by each discrete unit 222-224.

The embodiment(s) described above and illustrated in the figures are presented by way of example only and are not intended as a limitation upon the concepts and principles of the present subject matter. As such, it will be appreciated that variations and modifications to the elements and their configuration and/or arrangement may exist.

Various features of the present subject matter are set forth in the following claims.

What is claimed is:

1. A fan assembly comprising:
a base being securable to a surface, the base including:
a cavity, and
an inlet in fluid communication with the cavity;
a motor assembly disposed in the cavity,
the motor assembly being operable to draw air in through the inlet and into the cavity; and
a nozzle coupled to the base,
the nozzle defining a central axis oriented at an oblique angle relative to the surface, and
an outlet in fluid communication with the cavity of the base,
wherein the outlet is configured to direct the air out of the nozzle in a direction generally parallel to the central axis.

2. The fan assembly of claim 1, wherein the nozzle defines a channel in fluid communication with the cavity of the base and the outlet.

3. The fan assembly of claim 2 further comprising a heating element disposed within the channel, the heating element being configured to heat air passing through the channel.

4. The fan assembly of claim 1, wherein the outlet is configured to direct the air towards a mirrored surface.

5. The fan assembly of claim 1, wherein the nozzle includes an annularly shaped nozzle having an inner wall defining a central opening.

6. The fan assembly of claim 5 further comprising a light emitter disposed within the central opening, the light emitter being supported by the nozzle.

7. The fan assembly of claim 5, wherein the outlet extends around a perimeter of the inner wall of the nozzle.

8. A fan assembly comprising;
a base for attachment to a surface proximate to a mirror, the base at least partially defining:
a cavity, and
an inlet in fluid communication with the cavity;
a motor assembly disposed in the base,
the motor assembly being operable to draw air into the cavity through the inlet;
a nozzle including:
a first wall,
a second wall spaced apart from the first wall,
a central opening at least partially defined by the second wall,
a channel disposed between the first and second walls,
the channel being in fluid communication with the cavity of the base, and an outlet formed in the second wall,
the outlet being configured to direct air out of the nozzle toward the mirror;
a heating element positioned within the channel,
the heating element being configured to heat air passing through the channel; and
a light emitter supported by the nozzle,
the light emitter being configured to direct light through the central opening.

9. The fan assembly of claim 8, wherein the heating element includes a heating coil wrapped around the second wall of the annular nozzle.

10. The fan assembly of claim 8, wherein the nozzle is movable relative to the base.

11. The fan assembly of claim 8, wherein the base includes a cavity outlet formed in a surface between the base and the nozzle, and wherein the cavity outlet provides fluid communication between the cavity and the channel.

12. The fan assembly of claim 11, wherein at least a portion of the heating element is positioned proximate to the cavity outlet.

13. The fan assembly of claim 8, wherein the second wall includes a first segment and a second segment overlapping the first segment, and wherein the outlet is formed between the first and second segments.

14. A fan and mirror assembly comprising:
a mirror having a mirrored surface; and
a fan assembly disposed proximate to the mirror, the fan assembly including:
a base being securable to a wall above the mirror, the base defining:
an inlet, and
a cavity;
a motor assembly disposed in the base,
the motor assembly being configured to draw air into the cavity through the inlet,
a nozzle coupled to the base,
the nozzle defining:
a central axis oriented at an oblique angle relative to the mirrored surface, and
and
an outlet configured to direct air out of the nozzle in a direction generally parallel to the central axis and toward the mirrored surface,
a heating element supported by the nozzle for heating the air directed out of the nozzle, and
a light emitter supported by nozzle.

15. The fan and mirror assembly of claim 14, further comprising a plurality of fan assemblies disposed proximate to the mirror.

16. The fan and mirror assembly of claim 15, wherein fan assemblies of the plurality of fan assemblies are independently movable relative to the mirror.

17. The fan and mirror assembly of claim 14, wherein the light emitter includes an LED strip that.

18. The fan and mirror assembly of claim 14, wherein the heating element includes a heating coil.

19. The fan and mirror assembly of claim 14, wherein the nozzle is movable relative to the base.

20. The fan and mirror assembly of claim 14, wherein the outlet extends around a perimeter of an inner wall of the nozzle.
